(19) United States
(12) Patent Application Publication
(10) Pub. No.: US 2007/0145760 A1
(43) Pub. Date: Jun. 28, 2007

(54) VEHICLE DOOR CONTAINER HOLDER

(75) Inventors: Timothy S. Gresham, Woodhaven, MI (US); Michael W. Cass, Lenox, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/275,337

(22) Filed: Dec. 27, 2005

(51) Int. Cl. B60R 7/04

(52) U.S. Cl. 296/37.13

(57) ABSTRACT

The present invention relates to a vehicle door container holder. In at least one embodiment of the present invention, a vehicle door is disclosed which includes a door panel having a first wall and a second wall spaced from the first wall. The first and second walls help to form a cavity. In this embodiment, the door further includes an arm member moveable relative to at least the first wall, and a biasing member that extends between the door panel and the arm member. The biasing member cooperates with at least the first wall to be able to position a container within the cavity in a contacting relationship between the first wall and the arm member.

### BACKGROUND OF THE INVENTION

1. Field of the Invention

One aspect of the present invention relates to a vehicle door container holder.

2. Background Art

While in a vehicle, many people enjoy drinking a beverage. Often the beverages are in containers subject to tipping over during movements of the vehicle. To avoid tipping, manufacturers have formed cup holders in the passenger compartment of vehicles. However, some of these exhibit the disadvantages of being either too large or too small for the variety of containers in which beverages are dispensed. Containers can also move around, either spilling the contents of the container and/or making distracting noises.

Further, manufacturers have had to sacrifice critical spaces in the passenger compartment such as the console between seats, to accommodate these cup holders. In many instances, the critical space used can not be recovered when the cup holders are not in use. Moving these cup holders to spaces that feature lower usage intensity can result in fixed dimension cup holders that may have one or more of the disadvantages of spilling contents, making distracting noises, or the disadvantage of awkward positioning such as slanted cup holders. Slanted cup holders may require the use of sealed containers and may often force the manufacturer to place unsightly warning labels in the passenger compartment to caution against using open containers in these cup holders.

In view of the foregoing, what is needed is a manner of retaining containers in the passenger compartment of vehicles which does not use critical spaces, which does not occupy substantial passenger compartment space when not in use, which can inhibit spillage and/or distracting noises, and which can be used with many differently sized and shaped containers.

### SUMMARY OF THE INVENTION

In at least one embodiment of the present invention, a vehicle door is provided which includes a door panel having a first wall and a second wall spaced from the first wall. The first and second walls help to form a cavity. In this embodiment, the door further includes an arm member moveable relative to at least the first wall, and a biasing member that extends between the door panel and the arm member. In at least this embodiment, the biasing member cooperates with at least the first wall to be able to position a container within the cavity in a contacting relationship between the first wall and the arm member.

In another embodiment, a container holder for a vehicle door is provided. In this embodiment the container holder includes a substrate having at least a first surface defining a portion of a cavity and a moveable member connected to the substrate. In at least this embodiment, the moveable member cooperates with the first surface to enable a container to be supported within the cavity in a contacting relationship between the moveable member and the first surface. In this embodiment, the substrate is attached to a vehicle door and forms a portion of a passenger compartment of the vehicle.

In another embodiment, a method for retaining a container in a vehicle door is provided. In this embodiment, the method includes providing a vehicle door having a cavity portion and providing a moveable member within the cavity portion. The moveable member is capable of movement in response to a force to be able to support a container in a contacting relationship with the vehicle door and the moveable member within the cavity portion.

### BRIEF DESCRIPTION OF THE DRAWINGS

FIG. 1 shows an application of an embodiment of the present invention on a vehicle door;

FIG. 2 shows a vehicle container holder made in accordance with an embodiment of the present invention;

FIGS. 3a, 3b and 3c show a vehicle container holder made in accordance with another embodiment of the present invention; and

FIG. 4 shows a vehicle container holder made in accordance with yet another embodiment of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention. Moreover, unless expressly stated to the contrary, and the description of a group or class of components or materials as suitable preferred for a given purpose in connection with the invention implies that mixtures of any two or more members of the group or class may be equally suitable or preferred.

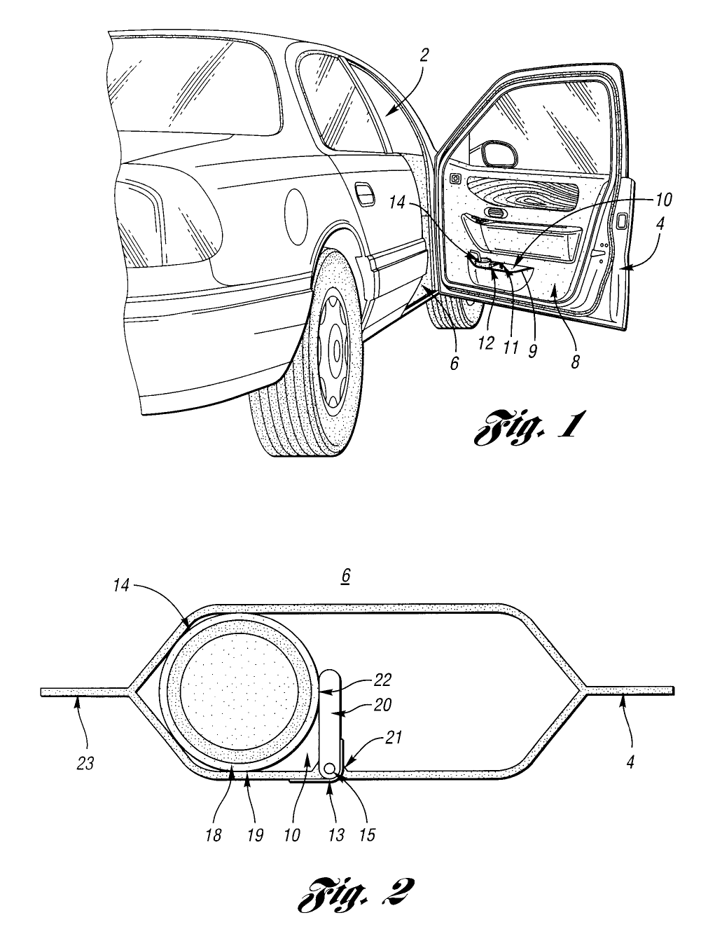

Referring to FIG. 1, this figure schematically shows a general application of an embodiment of the present invention on a vehicle door 4 of a vehicle 2. While illustrating a front passenger door 4, it should be understood that the present invention is applicable to all vehicle doors. The vehicle door 4 of the illustrated embodiment has a door panel 8 which is adjacent to the passenger compartment 6. The door panel 8 includes a cavity 10, which is defined at least in part by a first wall 9. In the illustrated embodiment, the first wall 9 cooperates with a movable arm member 12 to be able to securely position a container 14 within the cavity 10 in a contacting relationship between the first wall 9 and the arm member 12.

While the cavity 10 is illustrated to be a stationary map pocket, however, it should be understood that the cavity 10 could be provided in other structures. For instance, non-limiting examples of the cavity 10 include an articulated map pocket, a storage net, an enclosed space having a slide cover, a hinged cover or an elastic closure, a channel, a molded holder, or combinations thereof.

In an embodiment of the present invention, the container 14 may be retained in the cavity 10 by the arm member 12 without tipping or causing a distracting noise. In some embodiments, the container 14 may be positioned within the cavity 10 at the end of the cavity nearest the front of the vehicle. While not wishing to be bound by any one influence, such positioning may provide additional stability against tipping during acceleration and deceleration.

In some embodiments, the arm member 12 may be of various dimensions and shapes. As illustrated in some embodiments, the arm member 12 can be relatively short in length, but sufficient in length to enable a contacting relationship between the wall 9, the arm member 12, and the container 14, while occupying relatively small space in the passenger compartment 6. In other embodiments, the arm member 12 may be relatively longer to accommodate relatively larger containers and provide greater stability to the container 14 through relatively increased contact area. Non-limiting examples of the arm member 12 may include a retaining member, a moveable member 20 (FIG. 2), a sliding moveable member, an articulated arm, an elastomeric rod-like attachment, a beam, a curved arm, a series of fingers cooperating with a moveable portion, a baffle, a relatively conforming surface attached to a rigid body, such as a rubber insert, or combinations thereof.

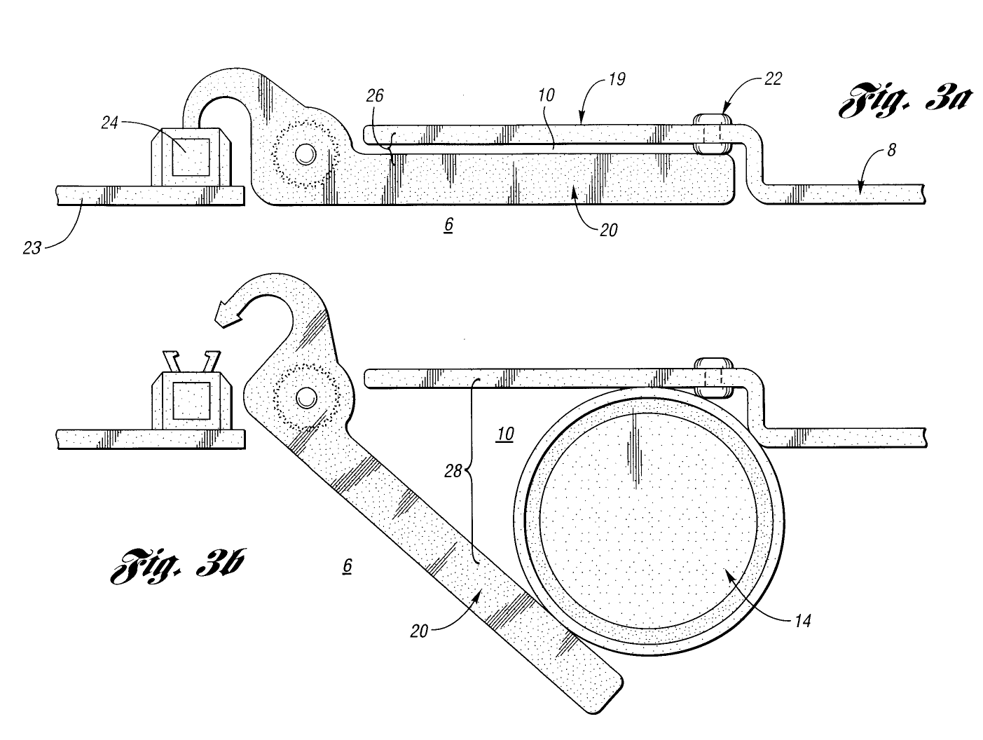

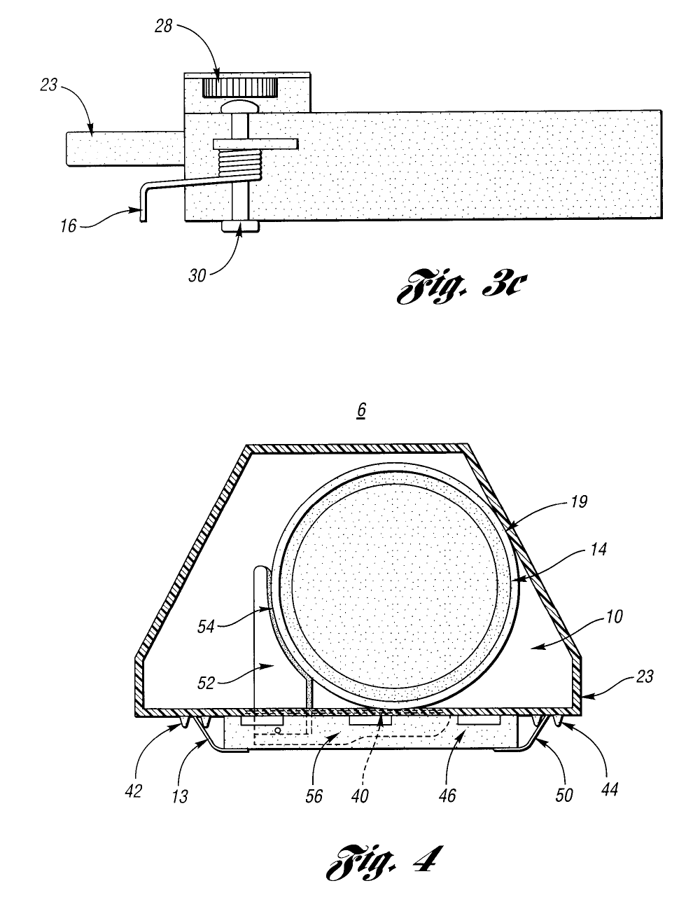

The arm member 12 (FIG. 1) may be biased for several different purposes. Non-limiting examples of such bias may include bias to assist in positioning of the arm member 12 during opening, bias to assist repositioning of the arm member 12 during closing, and/or bias to provide compressive force to relatively increase the stability of the container 14 having a relatively larger momentum as well as reduce the tendency for the container 14 to make distracting noises. The biasing member 11 (FIG. 1) should apply a bias sufficient to the arm member 12, such that the arm member 12 can cooperate with the first wall 9 to be able to securely position the container 14 within the cavity 10. Non-limiting examples of the biasing member 11 include a force applying member 13, such as a spring, a coiled spring, a leaf spring, an overcenter spring 32 (FIG. 3c), a stretched elastic member, a magnetic member, a gear member, a cam, a ratchet, or combinations thereof. The biasing member 11 may be modified by means to trigger the force or to dampen the force in response to consumer preferences. Non-limiting examples of the consumer preference may be for fingertip control for opening and closing of the arm member 12. The preference may also be for a mechanism that assures relatively reproducible opening positioning and closing positioning. Non-limiting examples may include triggering the biasing member using a push-push release mechanism 24 (FIG. 3a); or dampening the bias with a viscous gear dampener 18 (FIG. 3a).

Referring to FIG. 2, this figure shows an embodiment of the present invention including a container holder for use in the vehicle door 4. The vehicle door 4 has a substrate 23 that includes cavity 10. The illustrated cavity 10 is defined, at least in part, by a first surface 19. As with the other illustrated cavities 10, while the cavity 10 shown in FIG. 2 is illustrated as having a certain number of shaped surfaces, it should be understood that the cavity may be defined by any number of and/or varying shapes of surfaces. In the illustrated embodiment, the moveable member 20 is connected to a stationary member 21 at a pivot 15 by a force applying member 13, such as the illustrated leaf spring. In at least this embodiment, the force applying member (leaf spring) 13 biases the movable member 20 relative to the first surface 19. In one embodiment, the force applying member 13 biases the movable member 20 towards the first surface 19. In another embodiment, the force applying member 13 biases the movable member 20 away from the first surface 19. The amount of bias can vary as desired. Non-limiting examples of the stationary member 21 may include a portion of the substrate 23, an insert connected to the substrate 23, a free-standing insert, a framework connected to portions of the vehicle other than the substrate 23, and combinations thereof. In at least the illustrated embodiment, the substrate 23 includes the first surface 19 which, along with other surfaces that define the cavity 10, and the movable member 20, help to support the container 14 within the cavity 10.

Referring to FIGS. 3a, 3b and 3c, in another embodiment of the present invention, alternative components for the container holder for a vehicle door and a method for use are disclosed. Referring to FIGS. 3a, 3b, and 3c, the substrate 23 having the first surface 19 defines a portion of the cavity 10. The cavity 10 may be defined, in part, by surfaces of door panel 8 including the first surface 19. As set forth above, the cavity 10 is defined by the first surface 19 and a plurality of other surfaces. In the illustrated embodiment, a moveable member 20 is connected to the substrate 23 and cooperates with the surface 19 to enable positioning the container 14. In at least one embodiment, the moveable member 20 is biased relative to the first surface 19 with a force applying member 12 which in this embodiment is an overcenter spring 16.

In this embodiment, a relatively longer moveable member 20 may be used to increase the relative range of dimensions of the container 14 that can be accommodated. Stabilizing such relatively larger containers may require a relatively greater area of the moveable member 20 in contact with the container 14.

In at least one embodiment, the moveable member 20 may be triggered from a closed position 26 into an open position 28 by a push-push mechanism 24. The rate of opening may be modified to be more pleasing to vehicle users by the viscous gear dampener 28 located on a hinge pin 30. When open, the cavity 10 is able to receive the container 14. When the container 14 is removed from the cavity 10, in at least one embodiment, the moveable member 20 may be repositioned from the open position 28 to the closed position 26 using the push-push mechanism 24. In at least one embodiment, in the closed position 26, the moveable member 20 is approximately parallel to the vehicle door 4 and no longer occupying substantial space in the passenger compartment 6. As is illustrated, a rubber bumper 22 may be attached to the substrate 23 to enable a relative reduction in distracting noise.

Referring to FIG. 4, in another embodiment of the present invention a sliding moveable member is described. Referring to FIG. 4, a container holder for a vehicle door includes a substrate 23 having a first surface 19. In the illustrated embodiment, attached to the substrate 23 is a sliding track mechanism 40. Approximately in-line with the sliding track mechanism 40 are a first detent 42 and a second detent 44. Slidingly engaged to the sliding track mechanism 40 is a moveable member 46. Attached to the moveable member 46 is a force applying member 13, such as a spring, which can interfere with the first detent 42. Also attached to the moveable member is a stopping member 50, such as a spring. The stopping member 50 engages the second detent 44 to help position the moveable member 46. The moveable member 46 includes an arm member 52. The arm member 52 may be unitized with the movable member, positioned in a fixed position, or may move to a closed position 56 when no container is present, thereby no longer occupying substantial space in the passenger compartment 6. The arm member 52 may also be modified to have a relatively conformable surface 54 such as a rubber edge for improved reduction of distracting noise arising from relatively more rigid surfaces vibrating against the container 14. The illustrated positioning of the moveable member 46, the sliding track mechanism 40, the first detent 42, and the second detent 44, should be understood to be a non-limiting example. As a non-limiting example, the moveable member 46 may be located on side of the substrate 23 located closer to the passenger compartment 6, and may help to define a portion of the cavity 10.

Non-limiting examples of the sliding track mechanism 40 include a channel, a channel having disc-shaped rollers, a channel having ball bearings, a sliding bearing mechanism, a telescoping mechanism, a linear motion mechanism, or combinations thereof. The arm member 52 may be fabricated or assembled by different methods. Non-limiting examples of the arm member 52 assembly and/or fabrication may include having the arm member as a unitized portion of the moveable member 46, as a moveable portion fixed to the moveable member 46, or as an independently moveable arm member 52. The magnitude to which the arm member 52 may move independently of the moveable member 46 may help determine the presence and magnitude of application of compressive force to the container 14 derived from the force applying member 13. Non-limiting examples of the movement of the moveable member 46 when applying compressive force may include translational motion, rotary motion, or combinations thereof.

A non-limiting example of the force applying member 13 may include springs, such as a leaf spring or a coiled spring, a hydraulic cylinder, a gear, a ratchet, or magnets. Non-limiting examples of the function of the stopping member include applying a countering force to the force applied by the force applying member 13 or providing frictional fixed stopping action. Non-limiting examples of the stopping member 50 and the force applying member 13 may include springs, the gear, the ratchet, or combinations thereof.

While the best mode for carrying out the invention has been described in detail, those familiar with the art to which this invention relates will recognize various alternative designs and embodiments for practicing the invention.

What is claimed is:

1. A vehicle door, comprising:
(a) a door panel having a first wall and a second wall spaced from the first wall, the first and second walls helping to form a cavity;
(b) an arm member moveable relative to at least the first wall; and
(c) a biasing member extending between the door panel and the arm member, wherein the biasing member cooperates with at least the first wall to be able to position a container within the cavity in a contacting relationship between the first wall and the arm member.

2. The vehicle door in claim 1, wherein the arm member is articulated.

3. The vehicle door in claim 1, wherein the door panel forms a portion of a passenger compartment of the vehicle.

4. A vehicle door in claim 1, wherein the biasing member and the first wall cooperate to position the container substantially vertically within the cavity.

5. A container holder for a vehicle door, comprising:
(a) a substrate having at least a first surface defining a portion of a cavity; and
(b) a moveable member connected to the substrate, the moveable member cooperating with the first surface to enable a container to be supported within the cavity in a contacting relationship between the moveable member and the first surface, wherein the substrate is attached to a vehicle door and forms a portion of a passenger compartment of the vehicle.

6. The holder of claim 5, further comprising a force applying member extending between and connecting the moveable member and a stationary member.

7. The holder of claim 6, wherein the stationary member is the substrate.

8. The holder of claim 6, wherein the force applying member is a spring.

9. The holder of claim 8, wherein the spring is a coiled spring.

10. The holder of claim 9, wherein the coiled spring is an overcenter spring.

11. A holder of claim 6, further comprising:
a slide track mechanism,
a first detent,
a second detent, and
a stopping member,
wherein the slide track, the first and the second detents are attached to the substrate, the stopping member is attached to moveable member, the moveable member is slidingly engaged with the slide track mechanism, and the force applying member interferes with the first detent to apply a force to the moveable member, and the stopping member interferes with the second detent to help position the moveable member.

12. The holder of claim 5, wherein the moveable member is pivotally attached to the substrate.

13. The holder of claim 5, wherein the moveable member is slidingly attached to the substrate.

14. The holder of claim 5, wherein the substrate is a map pocket.

15. The holder of claim 5, wherein the moveable member is positioned opposing the substrate when no container is present.

16. A method for retaining a container in a vehicle door, comprising:
(a) providing a vehicle door having a cavity portion; and
(b) providing a moveable member within the cavity portion, wherein the moveable member is capable of movement in response to a force to be able to support a container in a contacting relationship with the vehicle door and the moveable member within the cavity portion.

17. The method of claim 16, wherein the force is applied by a spring.

18. The method of claim 16, further comprising: operating a push-push mechanism to position the moveable member.

19. The method of claim 16, wherein the force is applied translationally.

20. The method of claim 16, further comprising:
(c) removing the container from the cavity, and
(d) repositioning the moveable member to be approximately parallel to the vehicle door.
